(19) United States
(12) Patent Application Publication
(10) Pub. No.: US 2026/0159625 A1
(43) Pub. Date: Jun. 11, 2026

(54) RESIN COMPOSITION, OPTICAL FIBER, OPTICAL FIBER MANUFACTURING METHOD, OPTICAL FIBER RIBBON, AND OPTICAL FIBER CABLE

(71) Applicant: SUMITOMO ELECTRIC INDUSTRIES, LTD., Osaka-shi, Osaka (JP)

(72) Inventor: Yuya HOMMA, Osaka-shi, Osaka (JP)

(21) Appl. No.: 18/723,959

(22) PCT Filed: May 1, 2024
(86) PCT No.: PCT/JP2024/016812

§ 371 Date: Jun. 25, 2024

(30) Foreign Application Priority Data
Jun. 1, 2023 (JP) 2023-090943

(51) Int. Cl. C08F 290/06; C03C 25/1065; C03C 25/285; C03C 25/40; C03C 25/6226; G02B 6/44

(52) U.S. Cl. CPC C08F 290/067; C03C 25/1065; C03C 25/285; C03C 25/40; C03C 25/6226; G02B 6/443; G02B 6/4434

(57) ABSTRACT

A resin composition for primary coating of an optical fiber contains a photopolymerizable compound containing a urethane (meth)acrylate derived from a plant component, a photopolymerization initiator and a silane coupling agent.

### TECHNICAL FIELD

The present disclosure relates to a resin composition for primary coating of an optical fiber, an optical fiber, a method for manufacturing an optical fiber, an optical fiber ribbon and an optical fiber cable.

The present application claims priority based on Japanese Patent Application No. 2023-090943, filed Jun. 1, 2023, and all of the contents described in the Japanese Patent Application are incorporated herein by reference.

### BACKGROUND ART

Generally, an optical fiber includes a coating resin layer for protecting a glass fiber, which is an optical transmission medium. The coating resin layer is composed of, for example, two layers of a primary resin layer that is in contact with a glass fiber and a secondary resin layer that is formed on the outer layer of the primary resin layer. For example, Patent Literature 1 to 5 describe resin compositions for primary coating containing a photopolymerizable compound such as a urethane (meth)acrylate.

### CITATION LIST

### Patent Literature

Patent Literature 1: JP 2009-197163A
Patent Literature 2: JP 2012-111674A
Patent Literature 3: JP 2013-136783A
Patent Literature 4: JP 2013-501125T
Patent Literature 5: JP 2014-114208A

### SUMMARY OF INVENTION

A resin composition for primary coating of an optical fiber according to one aspect of the present disclosure contains a photopolymerizable compound containing a urethane (meth)acrylate derived from a plant component, a photopolymerization initiator and a silane coupling agent.

### BRIEF DESCRIPTION OF DRAWINGS

FIG. 1 is a schematic cross-sectional view showing one example of an optical fiber according to the present embodiment.

FIG. 2 is a schematic cross-sectional view showing an optical fiber ribbon according to one embodiment.

FIG. 3 is a schematic cross-sectional view showing an optical fiber ribbon according to one embodiment.

FIG. 4 is a plan view showing the appearance of an optical fiber ribbon according to one embodiment.

FIG. 5 is a schematic cross-sectional view showing an optical fiber cable according to one embodiment.

FIG. 6 is a schematic cross-sectional view showing an optical fiber cable according to one embodiment.

### DESCRIPTION OF EMBODIMENTS

### Problems to be Resolved by Present Disclosure

Recently, importance has been given to an activity for realizing sustainable development goals (SDGs) in each industry. As one of such activities, there is a demand for contribution to a recycling society by the utilization of renewable resources. One example of the renewable recourses is a biomass resource obtained by processing a plant-derived raw material. The utilization of a biomass resource is considered to be important from the viewpoint of carbon neutral, and there is thus a demand for forming a coating resin layer using a resin composition having a high biomass degree even in the field of optical fibers. However, it is difficult to maintain the performance such as low-temperature characteristic of an optical fiber only by forming a coating resin layer simply using a plant-derived raw material.

An object of the present disclosure is to provide a resin composition having a high biomass degree and capable of forming a resin layer suitable for the primary coating of an optical fiber and an optical fiber having excellent low-temperature characteristic.

### Effects of Present Disclosure

According to the present disclosure, it is possible to provide a resin composition having a high biomass degree and capable of forming a resin layer suitable for the primary coating of an optical fiber and an optical fiber having excellent low-temperature characteristic.

### Description of Embodiments of Present Disclosure

First of all, the contents of an embodiment of the present disclosure will be listed and described.

(1) A resin composition for primary coating of an optical fiber according to one aspect of the present disclosure contains a photopolymerizable compound containing a urethane (meth)acrylate derived from a plant component, a photopolymerization initiator and a silane coupling agent. Such a resin composition has a high biomass degree, is capable of forming a resin layer suitable for the primary coating of an optical fiber and is capable of improving the low-temperature characteristic of an optical fiber.

(2) In the (1), the urethane (meth)acrylate may have a biomass degree of 20% or more and 70% or less from the viewpoint of further improving the low-temperature characteristic of an optical fiber.

(3) In the (1) or (2), the urethane (meth)acrylate may have a weight-average molecular weight of 5000 or more and 35000 or less from the viewpoint of further improving the low-temperature characteristic of an optical fiber.

(4) In any one of the (1) to (3), a content of the urethane (meth)acrylate may be 10 parts by mass or more and 80 parts by mass or less based on 100 parts by mass of a total amount of the resin composition from the viewpoint of further improving the low-temperature characteristic of an optical fiber.

(5) In any one of the (1) to (4), the photopolymerizable compound may further contain a monomer derived from a plant component from the viewpoint of further increasing the biomass degree.

(6) In any one of the (1) to (5), the photopolymerizable compound may further contain a N-vinyl compound, and a content of the N-vinyl compound may be 1 part by mass or more and 15 parts by mass or less based on 100 parts by mass of a total amount of the resin composition from the viewpoint of improving the curing rate of the resin composition.

(7) In any one of the (1) to (6), the resin composition may have a biomass degree of 10% or more and 50% or less from the viewpoint of further improving the low-temperature characteristic of an optical fiber.

(8) An optical fiber according to one aspect of the present disclosure includes a glass fiber including a core and a clad, a primary resin layer being in contact with the glass fiber and coating the glass fiber and a secondary resin layer coating the primary resin layer, and the primary resin layer contains a cured product of the resin composition according to any one of the (1) to (7). Such an optical fiber has low-temperature characteristic similar to or better than those of conventional optical fibers and is also capable of contributing to carbon neutral.

(9) A method for manufacturing an optical fiber according to one aspect of the present disclosure includes an applying step of applying the resin composition according to any one of the (1) to (7) to an outer circumference of a glass fiber including a core and a clad and a curing step of curing the resin composition by radiating an ultraviolet ray after the applying step. This makes it possible to produce an optical fiber having excellent low-temperature characteristic.

(10) In an optical fiber ribbon according to one aspect of the present disclosure, a plurality of the optical fibers according to the (8) are arranged in parallel and coated with a ribbon resin. Such an optical fiber ribbon has excellent low-temperature characteristic and can be highly densely stored into an optical fiber cable.

(11) In an optical fiber cable according to one aspect of the present disclosure, the optical fiber ribbon according to the (10) is stored in a cable. Such an optical fiber cable has excellent low-temperature characteristic.

(12) In an optical fiber cable according to one aspect of the present disclosure, a plurality of the optical fibers according to the (8) are stored in a cable. Such an optical fiber cable has excellent low-temperature characteristic.

### Details of Embodiments of Present Disclosure

A specific example of a resin composition and an optical fiber according to the present embodiment will be described with reference of drawings as necessary. The present disclosure is not limited to these exemplifications, is indicated by claims and is intended to include all changes within the meaning and range equivalent to the claims. In the following description, the same elements in the description of the drawings will be given the same reference sign, and duplicate description will not be made. (Meth)acrylates in the present specification means acrylates and methacrylates corresponding thereto, which is also true for other similar expressions such as (meth)acryloyl. In addition, PO modification means propylene oxide modification, and EO modification means ethylene oxide modification. In the present specification, ppm indicates a mass ratio.

The biomass degree in the present specification means “mass %” derived from a plant component (biomass-derived component) in a resin composition or a raw material. For example, in a case where there is a raw material A having a molecular weight of 100, the plant-derived molecular weight is 70 and the petroleum-derived molecular weight is 30, the biomass degree of the raw material A becomes 70%. In addition, the biomass degree of a resin composition obtained by mixing 60 g of a raw material B having a biomass degree of 30% and 40 g of a raw material C having a biomass degree of 50% becomes (60 g×30%+40 g×50%)/(60 g+40 g)=38%.

### (Resin Composition)

The resin composition for primary coating of an optical fiber according to the present embodiment contains a photopolymerizable compound containing a urethane (meth)acrylate derived from a plant component, a photopolymerization initiator and a silane coupling agent. The urethane (meth)acrylate derived from a plant component (hereinafter, referred to as “urethane (meth)acrylate (A)”) is urethane (meth)acrylate synthesized using a plant-derived raw material. The use of the urethane (meth)acrylate (A) makes it possible to form a resin layer having a high biomass degree and makes it possible to improve the low-temperature characteristic of an optical fiber.

The biomass degree of the resin composition according to the present embodiment may be 10% or more, 13% or more or 15% or more and may be 50% or less, 45% or less, 40% or less or 35% or less from the viewpoint of further improving the low-temperature characteristic of an optical fiber. The biomass degree of the resin composition according to the present embodiment may be 10% or more and 50% or less, 10% or more and 45% or less, 13% or more and 40% or less or 15% or more and 35% or less from the viewpoint of further improving the low-temperature characteristic of an optical fiber.

The biomass degree of the urethane (meth)acrylate (A) may be 20% or more, 25% or more, 30% or more, 35% or more, 40% or more, 45% or more or 50% or more and may be 70% or less, 65% or less, 60% or less or 55% or less from the viewpoint of further improving the low-temperature characteristic of an optical fiber. The biomass degree of the urethane (meth)acrylate (A) may be 20% or more and 70% or less, 25% or more and 65% or less, 30% or more and 60% or less or 35% or more and 55% or less from the viewpoint of further improving the low-temperature characteristic of an optical fiber.

Generally, the urethane (meth)acrylate can be obtained by a reaction among a polyol, a polyisocyanate and a hydroxyl group-containing (meth)acrylate (or an isocyanate group-containing (meth)acrylate). As the polyol, there are plant-derived polyols and petroleum-derived polyols, and as the polyisocyanate, there are plant-derived polyisocyanates and petroleum-derived polyisocyanates.

The urethane (meth)acrylate (A) can be synthesized using at least one of a plant-derived polyol and a plant-derived polyisocyanate as a raw material. When synthesizing the urethane (meth)acrylate (A), a plant-derived polyol and a petroleum-derived polyol may be used together and a plant-derived polyisocyanate and a petroleum-derived polyisocyanate may be used together.

Examples of the plant-derived polyol include plant-derived polyester polyols, plant-derived polyether polyols, plant-derived polycarbonate polyols, soybean oil-modified polyols, castor oil-modified polyols, algae-derived polyols and cardanol polyols.

Examples of the plant-derived polyester polyols include polyester polyols having a dimer acid-derived structure, polyester polyols having a 1,3-propanediol-derived structure and polyester polyols for which castor oil-derived sebacic acid is used.

Examples of the plant-derived polyether polyols include polyether polyols obtained by the ring-opening polymerization of tetrahydrofuran, polyether polyols obtained by the copolymerization of tetrahydrofuran and 2-methyltetrahydrofuran and polyether polyols obtained by the polymerization of 1,3-propanediol.

Examples of the plant-derived polycarbonate polyols include isosorbide-derived polycarbonate polyols and polycarbonate polyols having a structure derived from 1,10-decanediol.

Examples of the petroleum-derived polyol include polyethylene glycol (PEG), polypropylene glycol (PPG), PEG-PPG-PEG block copolymer, polycarbonate diol, polybutadiene diol and bisphenol A/ethylene oxide-addition diol.

Examples of the plant-derived polyisocyanate include 1,5-pentamethylene diisocyanate, dimer acid diisocyanate, lysine diisocyanate, lysine triisocyanate, octamethylene diisocyanate and decamethylene diisocyanate.

Examples of the petroleum-derived polyisocyanate include 2,4-tolylene diisocyanate, 2,6-tolylene diisocyanate, isophorone diisocyanate, dicyclohexylmethane diisocyanate, diphenylmethane diisocyanate, hexamethylene diisocyanate, xylylene diisocyanate, hydrogenated xylylene diisocyanate, 1,5-naphthalene diisocyanate, norbornene diisocyanate, tetramethylxylylene diisocyanate and trimethylhexamethylene diisocyanate.

Examples of the hydroxyl group-containing (meth)acrylate include 2-hydroxyethyl (meth)acrylate, 2-hydroxypropyl (meth)acrylate, 2-hydroxybutyl (meth)acrylate, caprolactone (meth)acrylate, 2-hydroxy-3-phenoxypropyl (meth)acrylate, 2-(meth)acryloyloxyethyl-2-hydroxyethylphthalate, 2-hydroxy-o-phenylphenolpropyl (meth)acrylate, 2-hydroxy-3-methacrylpropyl acrylate, trimethylolpropane di(meth)acrylate and pentaerythritol tri(meta)acrylate.

The urethane (meth)acrylate (A) may have two or more, three or more or four or more (meth)acryloyl groups, which are photopolymerizable functional groups.

The glass transition temperature (Tg) of a homopolymer of the urethane (meth)acrylate (A) may be 0° C. or lower, −20° C. or lower, −40° C. or lower or −60° C. or lower from the viewpoint of further improving the low-temperature characteristic of an optical fiber. Tg can be measured by the dynamic viscoelasticity test of the homopolymer.

The number-average molecular weight (Mn) of the urethane (meth)acrylate (A) may be 10000 or more, 11000 or more, 12000 or more or 13000 or more and may be 50000 or less, 45000 or less, 40000 or less, 30000 or less, 20000 or less or 15000 or less from the viewpoint of further improving the low-temperature characteristic of an optical fiber. The number-average molecular weight (Mn) of the urethane (meth)acrylate (A) may be 10000 or more and 50000 or less, 11000 or more and 45000 or less, 12000 or more and 40000 or less or 13000 or more 30000 or less from the viewpoint of further improving the low-temperature characteristic of an optical fiber. The weight-average molecular weight (Mw) of the urethane (meth)acrylate (A) may be 5000 or more, 10000 or more, 15000 or more, 20000 or more and 21000 or more and may be 35000 or less, 30000 or less or 25000 or less from the viewpoint of further improving the low-temperature characteristic of an optical fiber. The weight-average molecular weight (Mw) of the urethane (meth)acrylate (A) may be 5000 or more and 35000 or less, 10000 or more and 35000 or less, 15000 or more and 35000 or less, 20000 or more and 30000 or less or 21000 or more 30000 or less from the viewpoint of further improving the low-temperature characteristic of an optical fiber.

Examples of a commercially available product of the urethane (meth)acrylate (A) include SARBIO 7300NS, SARBIO 7302NS, SARBIO 7403NS, SARBIO 7404NS, SARBIO 7405NS and SARBIO 7406NS manufactured by Arkema; UFB-C01 and UFB-0146 manufactured by Kyoeisha Chemical Co., Ltd.; UT-8166, UT-8200, UT-7792 and UT-7999 manufactured by Mitsubishi Chemical Corporation; and 8UX-2017A manufactured by Taisei Fine Chemical Co., Ltd.

The content of the urethane (meth)acrylate (A) may be 10 parts by mass or more, 15 parts by mass or more, 20 parts by mass or more or 25 parts by mass and may be 80 parts by mass or less, 75 parts by mass or less, 70 parts by mass or less, 60 parts by mass or less, 50 parts by mass or less, 45 parts by mass or less, 40 parts by mass or less or 35 parts by mass or less based on the 100 parts by mass of the total amount of the resin composition from the viewpoint of further improving the low-temperature characteristic of an optical fiber. The content of the urethane (meth)acrylate (A) may be 10 parts by mass or more and 80 parts by mass or less, 10 parts by mass or more and 75 parts by mass or less, 15 parts by mass or more and 70 parts by mass or less, 20 parts by mass or more and 60 parts by mass or less, 20 parts by mass or more and 50 parts by mass or less, 20 parts by mass or more and 45 parts by mass or less, 20 parts by mass or more and 40 parts by mass or less or 25 parts by mass or more and 35 parts by mass or less based on the 100 parts by mass of the total amount of the resin composition from the viewpoint of further improving the low-temperature characteristic of an optical fiber.

The photopolymerization compound may further contain urethane (meth)acrylate for which a plant-derived raw material is not used (hereinafter, referred to as “urethane (meth)acrylate (B)”) from the viewpoint of the coatability of the resin composition. Examples of the urethane (meth)acrylate (B) include reactants of a petroleum-derived polyol, a petroleum-derived polyisocyanate and a hydroxyl group-containing (meth)acrylate (hereinafter, referred to as “urethane (meth)acrylate (B1)”) and reactants of a petroleum-derived polyoxyalkylene monoalkyl ether, a petroleum-derived polyisocyanate and a hydroxyl group-containing (meth)acrylate (hereinafter, referred to as “urethane (meth)acrylate (B2)”).

From the viewpoint of obtaining a Young's modulus suitable for a primary resin layer, the Mn of the petroleum-derived polyol that is used for the synthesis of the urethane (meth)acrylate (B1) may be 1800 or more and 20000 or less, 2000 or more and 19000 or less or 2500 or more and 18500 or less.

Examples of a method for preparing the urethane (meth)acrylate (B1) include a method in which a polyol and a polyisocyanate are reacted with each other to synthesize an isocyanate group (NCO)-terminated prepolymer and a hydroxyl group-containing (meth)acrylate is then reacted; a method in which a polyisocyanate and a hydroxyl group-containing (meth)acrylate are reacted with each other and a polyol is then reacted; and a method in which a polyol, a polyisocyanate and a hydroxyl group-containing (meth)acrylate are reacted at the same time. When preparing the urethane (meth)acrylate (B1), the hydroxyl group-containing (meth)acrylate may be used after being mixed with a monovalent alcohol or an active hydrogen-containing silane compound as necessary.

When a group based on a monovalent alcohol is introduced into the urethane (meth)acrylate (B1), it is possible to reduce the proportion of a (meth)acryloyl group, which is a photopolymerizable group, and to reduce the Young's modulus of the primary resin layer. Examples of the monovalent alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol and 3-methyl-2-butanol.

When a group based on an active hydrogen-containing silane compound is introduced into the urethane (meth)acrylate (B1), it is possible to reduce the proportion of the (meth)acryloyl group, which is a photopolymerizable group, to reduce the Young's modulus of the primary resin layer and to improve the adhesion to a glass fiber. Examples of the active hydrogen-containing silane compound include N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene) propylamine, N-phenyl-3-aminopropyltrimethoxysilane, 3-mercaptopropylmethyldimethoxysilane and 3-mercaptopropyltrimethoxysilane.

The molar ratio of NCO to OH (NCO/OH) when reacting the polyol and the polyisocyanate may be 1.1 or more and 4.0 or less, 1.2 or more and 3.5 or less or 1.4 or more and 3.0 or less. The molar ratio of the hydroxyl group-containing (meth)acrylate to NCO of the NCO-terminated prepolymer may be 1.00 or more and 1.15 or less or 1.03 or more and 1.10 or less. In the case of using the hydroxyl group-containing (meth)acrylate after being mixed with the active hydrogen-containing silane compound or the monovalent alcohol, the molar ratio of the total of the hydroxyl group-containing (meth)acrylate, the active hydrogen-containing silane compound and the monovalent alcohol to NCO of the NCO-terminated prepolymer may be 1.00 or more and 1.15 or less or 1.03 or more and 1.10 or less, and the molar ratio of the total of the active hydrogen-containing silane compound and the monovalent alcohol to NCO of the NCO-terminated prepolymer may be 0.01 or more and 0.50 or less.

The polyoxyalkylene monoalkyl ether that is used for the synthesis of the urethane (meth)acrylate (B2) is a compound having an oxyalkylene group, an alkoxy group and a hydroxyl group. Examples of the polyoxyalkylene monoalkyl ether include polyoxyethylene oleyl ether, polyoxyethylene lauryl ether, polyoxyethylene cetyl ether, polyoxyethylene stearyl ether, polyoxyethylene alkyl (C₁₂ to C₁₄) ether, polyoxyethylene tridecyl ether, polyoxyethylene myristyl ether, polyoxyethylene isostearyl ether, polyoxyethylene octyl dodecyl ether, polyoxyethylene cholesteryl ether, polyoxypropylene butyl ether, polyoxypropylene myristyl ether, polyoxypropylene cetyl ether, polyoxypropylene stearyl ether, polyoxypropylene lanolin alcohol ether, polyoxyethylene polyoxypropylene butyl ether, polyoxyethylene polyoxypropylene lauryl ether, polyoxyethylene polyoxypropylene cetyl ether, polyoxyethylene polyoxypropylene stearyl ether and polyoxyethylene polyoxypropylene decyl tetradecyl ether.

The polyoxyalkylene monoalkyl ether may contain polyoxypropylene monobutyl ether from the viewpoint of the compatibility of the resin composition. The Mn of the polyoxyalkylene monoalkyl ether may be 2000 or more and 10000 or less, 2100 or more and 8000 or less or 2200 or more and 7000 or less from the viewpoint of obtaining a Young's modulus suitable for the primary resin layer.

The Mn's of the polyol and the polyoxyalkylene monoalkyl ether can be calculated based on the following formula (I) by measuring the hydroxyl value based on JIS K 0070. The number of functional groups in a diol is two, and the number of functional groups in the polyoxyalkylene monoalkyl ether is one.

$$Mn = 56.1 \times number of functional groups \times 1000 / hydroxyl value \qquad ( I )$$

The Mn of the urethane (meth)acrylate (B1) may be 6000 or more and 50000 or less, 8000 or more and 45000 or less, 9000 or more and 40000 or less or 10000 or more and 30000 or less from the viewpoint of obtaining a Young's modulus suitable for the primary resin layer. The Mw of the urethane (meth)acrylate (B1) may be 6000 or more and 80000 or less, 8000 or more and 70000 or less, 10000 or more and 60000 or less or 15000 or more and 40000 or less. The Mn of the urethane (meth)acrylate (B2) may be 4000 or more and 20000 or less, 5000 or more and 18000 or less or 6000 or more and 15000 or less. The Mw of the urethane (meth)acrylate (B2) may be 4000 or more and 30000 or less, 4500 or more and 25000 or less or 5000 or more and 20000 or less.

The Mn's and Mw's of the urethane (meth)acrylate (A) and the urethane (meth)acrylate (B) can be measured by gel permeation chromatography (GPC).

As a catalyst when synthesizing the urethane (meth)acrylate (A) and the urethane (meth)acrylate (B), for example, an organic tin compound is used. Examples of the organic tin compound include dibutyltin dilaurate, dibutyltin diacetate, dibutyltin malate, dibutyltin bis(2-ethylhexyl mercaptoacetate), dibutyltin bis(isooctyl mercaptoacetate) and dibutyltin oxide.

When synthesizing the urethane (meth)acrylate (A) and the urethane (meth)acrylate (B), 4-methoxyphenol or 2,6-di-tert-butyl-p-cresol may be added as a polymerization inhibitor.

The content of the urethane (meth)acrylate (B) may be 20 parts by mass or more and 70 parts by mass or less, 25 parts by mass or more and 65 parts by mass or less, 30 parts by mass or more and 60 parts by mass or less, 35 parts by mass or more and 55 parts by mass or less or 40 parts by mass or more and 50 parts by mass or less based on 100 parts by mass of the total amount of the resin composition from the viewpoint of coatability.

The resin composition according to the present embodiment may further contain a photopolymerizable compound other than the urethane (meth)acrylate (A) and the urethane (meth)acrylate (B) (hereinafter, referred to as “monomer”) as the photopolymerizable compound. The monomer has no urethane bonds and can be thus differentiated from the urethane (meth)acrylate. Examples of the monomer include (meth)acrylic acid esters, N-vinyl compounds and (meth)acrylamide compounds. The monomer may be a monofunctional monomer having one photopolymerizable ethylenically unsaturated group or a multifunctional monomer having two or more ethylenically unsaturated groups. One monomer may be used singly or two or more monomers may be used in combination.

Examples of the monofunctional (meth)acrylic acid esters include methyl (meth)acrylate, ethyl (meth)acrylate, propyl (meth)acrylate, n-butyl (meth)acrylate, s-butyl (meth)acrylate, t-butyl (meth)acrylate, isobutyl (meth)acrylate, n-pentyl (meth)acrylate, isopentyl (meth)acrylate, hexyl (meth)acrylate, heptyl (meth)acrylate, 2-ethylhexyl (meth)acrylate, isooctyl (meth)acrylate, isodecyl (meth)acrylate, phenoxyethyl (meth)acrylate, benzyl (meth)acrylate, cyclic trimethylolpropane formal acrylate, dicyclopentenyl (meth)acrylate, dicyclopentenyloxyethyl (meth)acrylate, dicyclopentanyl (meth)acrylate, methoxypolyethylene glycol (meth)acrylate, butoxypolyethylene glycol (meth)acrylate, nonylphenol polyethylene glycol (meth)acrylate, nonylphenoxypolyethylene glycol (meth)acrylate, 3-phenoxybenzyl (meth)acrylate, methylphenoxyethyl (meth)acrylate, phenoxydiethylene glycol (meth)acrylate, phenoxypolyethylene glycol (meth)acrylate, m-phenoxybenzyl (meth)acrylate, 2-(2-ethoxyethoxy) ethyl (meth)acrylate, 2-hydroxy-3-phenoxypropyl acrylate, carboxyethyl (meth)acrylate, carboxypentyl (meth)acrylate and ωrboxy-polycaprolactone (meth)acrylate.

Examples of the multifunctional (meth)acrylic acid esters include bifunctional monomers such as ethylene glycol di(meth)acrylate, polyethylene glycol di(meth)acrylate, polypropylene glycol di(meth)acrylate, neopentyl glycol di(meth)acrylate, tripropylene glycol di(meth)acrylate, triethylene glycol di(meth)acrylate, cyclohexanedimethanol di(meth)acrylate, dipropylene glycol di(meth)acrylate, tetraethylene glycol di(meth)acrylate, hydroxypivalic acid neopentyl glycol di(meth)acrylate, 1,3-butylene glycol di(meth)acrylate, 1,4-butanediol di(meth)acrylate, diethylene glycol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyldiol di(meth)acrylate, 3-ethyl-1,8-octanediol di(meth)acrylate, tricyclodecanol di(meth)acrylate, 9,9-bis[4-(2-hydroxyethoxy)phenyl]fluorene di(meth)acrylate, bisphenol A epoxy di(meth)acrylate, bisphenol F epoxy di(meth)acrylate, EO adduct di(meth)acrylate of bisphenol A, EO adduct di(meth)acrylate of bisphenol F, PO adduct di(meth)acrylate of bisphenol A and PO adduct di(meth)acrylate of bisphenol F; and tri- or higher-functional monomers such as trimethylolpropane tri(meth)acrylate, trimethyloloctane tri(meth)acrylate, trimethylolpropane polyethoxytri(meth)acrylate, trimethylolpropane polypropoxytri(meth)acrylate, trimethylolpropane polyethoxypolypropoxytri(meth)acrylate, tris[(meth)acryloyloxyethyl]isocyanurate, pentaerythritol tri(meth)acrylate, pentaerythritol polyethoxytetra(meth)acrylate, pentaerythritol polypropoxytetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate and caprolactone-modified tris[(meth)acryloyloxyethyl]isocyanurate.

Examples of the (meth)acrylamide compounds include dimethyl(meth)acrylamide, diethyl (meth)acrylamide, (meth)acryloylmorpholine, hydroxymethyl (meth)acrylamide, hydroxyethyl (meth)acrylamide, isopropyl (meth)acrylamide, dimethylaminopropyl (meth)acrylamide, dimethylaminopropylacrylamide/methyl chloride salt, diacetone acrylamide, (meth)acryloylpiperidine, (meth)acryloylpyrrolidine, (meth)acrylamide, N-hexyl (meth)acrylamide, N-methyl (meth)acrylamide, N-butyl (meth)acrylamide, N-methylol (meth)acrylamide and N-methylolpropane (meth)acrylamide.

Examples of the N-vinyl compounds include N-vinylpyrrolidone, N-vinylcaprolactam, N-vinylmethyloxazolidinone, N-vinylimidazole and N-vinyl-N-methylacetamide.

When the monomer contains the N-vinyl compound, it is possible to improve the curing rate of the resin composition. The N-vinyl compound may contain at least one selected from N-vinylcaprolactam and N-vinylmethyloxazolidinone from the viewpoint of further improving the curing rate of the resin composition. The content of the N-vinyl compound may be 1 part by mass or more and 15 parts by mass or less, 2 parts by mass or more and 14 parts by mass or less or 3 parts by mass or more and 13 parts by mass or less based on 100 parts by mass of the total amount of the resin composition.

In order to further increase the biomass degree of the resin composition, a monomer derived from a plant component may be used as the monomer. Examples of the monomer derived from a plant component include normal octyl (meth)acrylate, lauryl (meth)acrylate, stearyl (meth)acrylate, isobornyl (meth)acrylate, tetrahydrofurfuryl (meth)acrylate, isoamyl (meth)acrylate, glycerin carbonate (meth)acrylate, glycerin di(meth)acrylate, decanediol di(meth)acrylate, glycerin tri(meth)acrylate, glycerin PO-modified tri(meth)acrylate, diglycerin EO-modified tetra (meth)acrylate, polyglycerin hexa (meth)acrylate and sorbitol EO-modified hexa (meth)acrylate. As the monomer derived from a plant component, one monomer may be used singly or two or more monomers may be used in combination.

The content of the monomer derived from a plant component may be 1 part by mass or more and 20 parts by mass or less, 1 part by mass or more and 15 parts by mass or less or 2 parts by mass or more and 15 parts by mass or less based on 100 parts by mass of the total amount of the resin composition.

The content of the monomer may be 10 parts by mass or more and 65 parts by mass or less, 10 parts by mass or more and 60 parts by mass or less, 10 parts by mass or more and 55 parts by mass or less, 15 parts by mass or more and 55 parts by mass or less or 20 parts by mass or more and 55 parts by mass or less based on 100 parts by mass of the total amount of the resin composition.

As the photopolymerization initiator, an initiator selected as appropriate from well-known radical photopolymerization initiators can be used. Examples of the photopolymerization initiator include 1-hydroxycyclohexyl phenyl ketone (Omnirad 184, manufactured by IGM Resins), 2,2-dimethoxy-2-phenylacetophenone (Omnirad 651, manufactured by IGM Resins), 2,4,6-trimethylbenzoyldiphenylphosphine oxide (Omnirad TPO, manufactured by IGM Resins), ethyl (2,4,6-trimethylbenzoyl)-phenylphosphinate (Omnirad TPO-L, manufactured by IGM Resins), 2-benzyl-2-dimethylamino-4′-morpholinobutyrophenone (Omnirad 369, manufactured by IGM Resins), 2-dimethylamino-2-(4-methyl-benzyl)-1-(4-morpholin-4-yl-phenyl)-but an-1-one (Omnirad 379, manufactured by IGM Resins), bis(2,4,6-trimethylbenzoyl)phenylphosphine oxide (Omnirad 819, manufactured by IGM Resins) and 2-methyl-1-[4-(methylthio)phenyl]-2-morpholinopropan-1-one (Omnirad 907, manufactured by IGM Resins).

One photopolymerization initiator may be used singly or two or more photopolymerization initiators may be mixed together and used. The photopolymerization initiator may contain 2,4,6-trimethylbenzoyldiphenylphosphine oxide from the viewpoint of excellent fast curing properties of the resin composition.

The content of the photopolymerization initiator may be 0.1 parts by mass or more and 5.0 parts by mass or less, 0.3 parts by mass or more and 4.0 parts by mass or less or 0.4 parts by mass or more and 3.0 parts by mass or less based on 100 parts by mass of the total amount of the resin composition.

Examples of the silane coupling agent include tetramethylsilicate, tetraethylsilicate, mercaptopropyltrimethoxysilane, vinyltrichlorosilane, vinyltriethoxysilane, vinyltris (β-methoxy-ethoxy) silane, β-(3,4-epoxycyclohexyl)-ethyltrimethoxysilane, dimethoxydimethylsilane, diethoxydimethylsilane, 3-(meth)acryloxypropyltrimethoxysilane, γ-glycidoxypropyltrimethoxysilane, γ-glycidoxypropylmethyldiethoxysilane, γ-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis-[3-(triethoxysilyl) propyl]tetrasulfide, bis-[3-(triethoxysilyl) propyl]disulfide, γ-trimethoxysilylpropyldimethylthiocarbamoyltetrasulfide and γ-trimethoxysilylpropylbenzothiazyltetrasulfide. One silane coupling agent may be used singly or two or more silane coupling agents may be used in combination.

The content of the silane coupling agent may be 0.1 parts by mass or more and 5.0 parts by mass or less, 0.3 parts by mass or more and 4.0 parts by mass or less or 0.4 parts by mass or more and 3.0 parts by mass or less based on 100 parts by mass of the total amount of the resin composition.

The resin composition according to the present embodiment may further contain a sensitizer, a photoacid generator, a surfactant, a leveling agent, an antifoaming agent, an antioxidant, an ultraviolet absorber or the like.

Examples of the sensitizer include anthracene compounds such as 9,10-dibutoxyanthracene, 9,10-diethoxyanthracene, 9,10-dipropoxyanthracene and 9,10-bis(2-ethylhexyloxy) anthracene, thioxanthone compounds such as 2,4-diethylthioxanthone, 2,4-diethylthioxanthene-9-one, 2-isopropylthioxanthone and 4-isopropylthioxanthone, amine compounds such as triethanolamine, methyldiethanolamine and triisopropanolamine, benzoin compounds, anthraquinone compounds, ketal compounds and benzophenone compounds.

As the photoacid generator, an onium salt having an A⁺B⁻ structure may be used. Examples of the photoacid generator include sulfonium salts such as CPI-100P, 101A, 110P, 200K, 210S, 310B and 410S (manufactured by San-Apro Ltd.) and Omnicat 270 and 290 (manufactured by IGM Resins) and iodonium salts such as CPI-IK-1 (manufactured by San-Apro Ltd.), Omnicat 250 (manufactured by IGM Resins), WPI-113, 116, 124, 169 and 170 (manufactured by Fujifilm Wako Pure Chemical Industries, Ltd.)

Examples of the surfactant include polyoxyethylene alkyl ether, polyoxyethylene sorbitan fatty acid ester, polyoxyethylene sorbitol fatty acid ester, polyoxyethylene monoester, polyoxyethylene diester, polyoxyethylene glyceryl isostearate, polyoxyethylene glyceryl triisostearate, sorbitan fatty acid ester, a compound represented by the following formula (1) and a compound represented by the following formula (2).

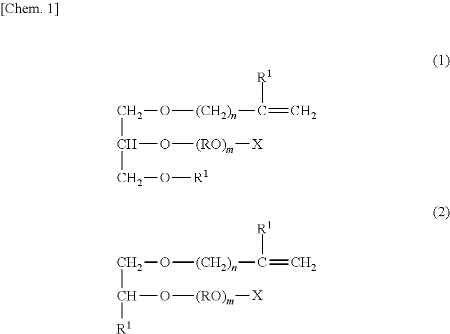

In the formula (1) and the formula (2), R represents an alkylene group having 2 to 4 carbon atoms, R¹ represents a hydrocarbon group having 1 to 20 carbon atoms, R² represents a hydrogen atom or a methyl group, X represents a hydrogen atom or a —SO₃NH₄ group, m represents an integer of 0 to 100, and n represents an integer of 0 to 12. In a case where m is 2 or more, a plurality of R's may be the same as or different from each other.

Examples of the alkylene group having 2 to 4 carbon atoms represented by R include an ethylene group, a propylene group and a butylene group. R may be an ethylene group from the viewpoint of being superior in terms of water resistance and oil resistance. The number of carbon atoms in the hydrocarbon group represented by R¹ may be 5 to 20, 8 to 18 or 10 to 15 from the viewpoint of being superior in terms of water resistance and oil resistance. The hydrocarbon group represented by R¹ may be linear, branched or cyclic. The hydrocarbon group represented by R¹ may be an aliphatic hydrocarbon group or an aromatic hydrocarbon group. Examples of the aliphatic hydrocarbon group include alkyl groups having 1 to 20 carbon atoms. Examples of the aromatic hydrocarbon group include phenyl groups substituted with an alkyl group. The number of carbon atoms in the alkyl group in the phenyl group substituted with the alkyl group may be 1 to 14 or 1 to 10. Examples of the phenyl groups substituted with an alkyl group include an octylphenyl group a nonylphenyl group. R² may be a hydrogen atom from the viewpoint of being superior in terms of water resistance and oil resistance. m may be an integer of 1 to 50, 2 to 40, 3 to 30, 4 to 25 or 5 to 20. n may be an integer of 0 to 10, 0 to 8, 0 to 6, 0 to 3 or 1 to 3.

Examples of the compound represented by the formula (1) include ADEKA REASOAP SR-10, SR-20, SR-1025, SR-2025, SR-3025, SE-10N, SE-1025A, ER-10, ER-20, ER-30, ER-40, NE-10, NE-20 and NE-30 manufactured by ADEKA Corporation. Examples of the compound represented by the formula (2) include AQUALON KH-05, KH-10 and KH-20 manufactured by DKS Co. Ltd.

The viscosity at 25° C. of the resin composition according to the present embodiment may be 0.5 Pas or more and 20 Pas or less, 0.8 Pas or more and 18 Pas or less, 1 Pads or more and 10 Pas or less, 1 Pas or more and 8 Pa·s or less or 1 Pa·s or more and 6 Pa·s or less from the viewpoint of the coatability. The viscosity at 25° C. of the resin composition can be measured using a rheometer (“MCR-102” manufactured by Anton Paar GmbH) with corn-plate CP25-2 under the conditions of a shear rate of 10 s⁻¹.

The Young's modulus of a resin film when curing the resin composition with ultraviolet rays under conditions of an integrated light quantity of 10 mJ/cm² and an illuminance of 100 mW/cm² (hereinafter, also referred to as “Young's modulus Y1”) may be 0.1 MPa or more and 1.0 MPa or less, 0.1 MPa or more and 0.8 MPa or less or 0.1 MPa or more and 0.6 MPa or less at 23° C. from the viewpoint of the low-temperature characteristic and microbend resistance of an optical fiber. From the same viewpoint, the Young's modulus of the resin film when curing the resin composition with ultraviolet rays under conditions of an integrated light quantity of 100 mJ/cm² and an illuminance of 100 mW/cm² (hereinafter, also referred to as “Young's modulus Y2”) may be 0.5 MPa or more and 2.0 MPa or less at 23° C. The ratio (Y1/Y2) of the Young's modulus Y1 to the Young's modulus Y2 may be 0.40 or more, 0.45 or more or 0.50 or more from the viewpoint of further improving the low-temperature characteristic of an optical fiber. As Y1/Y2 becomes higher, it is possible to more uniformly and more rapidly cure the resin composition, and the low-temperature characteristic of an optical fiber can be thus further improved.

### (Optical Fiber)

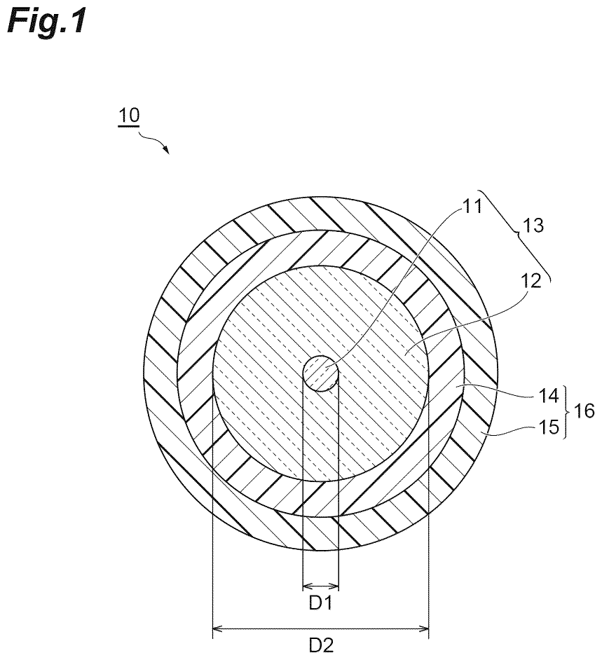

FIG. 1 is a schematic cross-sectional view showing one example of an optical fiber according to the present embodiment. An optical fiber 10 includes a glass fiber 13 including a core 11 and a clad 12 and a coating resin layer 16 including a primary resin layer 14 and a secondary resin layer 15 provided on the outer circumference of the glass fiber 13.

The clad 12 surrounds the core 11. The core 11 and the clad 12 mainly contains glass such as quartz glass, and, for example, it is possible to use quartz glass to which germanium is added or pure quartz glass for the core 11 and to use pure quartz glass or quartz glass to which fluorine is added for the clad 12.

In FIG. 1, for example, the outer diameter (D2) of the glass fiber 13 is approximately 100 μm to 125 μm, and the diameter (D1) of the core 11 that configures the glass fiber 13 is approximately 7 μm to 15 μm. The thickness of the coating resin layer 16 is normally approximately 22 μm to 70 μm. The thickness of each layer of the primary resin layer 14 and the secondary resin layer 15 may be approximately 5 μm to 50 μm.

In a case where the outer diameter of the glass fiber 13 is approximately 125 μm and the thickness of the coating resin layer 16 is 60 μm or more and 70 μm or less, the thickness of each layer of the primary resin layer 14 and the secondary resin layer 15 may be approximately 10 μm to 50 μm, and for example, the thickness of the primary resin layer 14 may be 35 μm and the thickness of the secondary resin layer 15 may be 25 μm. The outer diameter of the optical fiber 10 may be approximately 245 μm to 265 μm.

In a case where the outer diameter of the glass fiber 13 is approximately 125 μm and the thickness of the coating resin layer 16 is 20 μm or more and 48 μm or less, the thickness of each layer of the primary resin layer 14 and the secondary resin layer 15 may be approximately 8 μm to 38 μm, and for example, the thickness of the primary resin layer 14 may be 25 μm and the thickness of the secondary resin layer 15 may be 10 μm. The outer diameter of the optical fiber 10 may be approximately 165 μm to 221 μm.

In a case where the outer diameter of the glass fiber 13 is approximately 100 μm and the thickness of the coating resin layer 16 is 22 μm or more and 37 μm or less, the thickness of each layer of the primary resin layer 14 and the secondary resin layer 15 may be approximately 5 μm to 32 μm, and for example, the thickness of the primary resin layer 14 may be 25 μm and the thickness of the secondary resin layer 15 may be 10 μm. The outer diameter of the optical fiber 10 may be approximately 144 μm to 174 μm.

The primary resin layer 14 can be formed by curing the resin composition according to the present embodiment. The Young's modulus of the primary resin layer 14 may be 0.80 MPa or less, 0.70 MPa or less, 0.60 MPa or less or 0.50 MPa or less at 23° C.±2° C. from the viewpoint of improving the microbend resistance of the optical fiber. When the Young's modulus of the primary resin layer is 0.80 MPa or less, it becomes difficult for an external force to be transferred to the glass fiber, and there is a tendency that it becomes easy to suppress an increase in transmission loss by a microbend. The Young's modulus of the primary resin layer may be 0.10 MPa or more, 0.15 MPa or more or 0.20 MPa or more at 23° C.±2° C. from the viewpoint of further improving the low-temperature characteristic of the optical fiber.

The Young's modulus of the primary resin layer 14 can be measured by a pullout modulus (POM) method at 23° C. Two places of the optical fiber are fixed with two chucks, the coating resin layer (the primary resin layer and the secondary resin layer) between the two chucks is removed, next, one chuck is fixed, and the other chuck is gently moved in a direction opposite to the fixed chuck. In a case where the length of the portion of the optical fiber that is interposed by the moved chuck is set to L, the movement amount of the chuck is set to Z, the outer diameter of the primary resin layer is set to Dp, the outer diameter of the glass fiber is set to Df, the Poisson's ratio of the primary resin layer is set to n, and a load when moving the chuck is set to W, the Young's modulus of the primary resin layer can be obtained from the following equation.

$$Young ’ s modulus ( MPa ) = ( ( 1 + n ) W / π LZ ) \times ln ( Dp / Df )$$

The secondary resin layer 15 can be formed by, for example, curing a resin composition containing a photopolymerizable compound containing urethane (meth)acrylate, a photopolymerization initiator and the like. The resin composition that forms the secondary resin layer has a different composition from the resin composition for primary coating. The resin composition for secondary coating can be prepared using a well-known conventional technique.

The Young's modulus of the secondary resin layer 15 may be 600 MPa or more, 800 MPa or more or 1000 MPa or more at 23° C.±2° C. from the viewpoint of improving the microbend resistance of the optical fiber. The upper limit value of the Young's modulus of the secondary resin layer is not particularly limited and may be 3000 MPa or less, 2500 MPa or less or 2000 MPa or less at 23° C.±2° C. from the viewpoint of imparting appropriate toughness to the secondary resin layer.

The Young's modulus of the secondary resin layer 15 can be measured by the following method. First, the optical fiber is immersed in a solvent mixture of acetone and ethanol and only the coating resin layer is pulled out in a cylindrical shape. At this time, the primary resin layer and the secondary resin layer are in an integrated state, but the Young's modulus of the primary resin layer is 1/10000 or more and 1/1000 or less of the Young's modulus of the secondary resin layer, it is thus possible to ignore the Young's modulus of the primary resin layer. Next, the solvents are removed from the coating resin layer by vacuum drying, and a tensile test (the tensile rate is 1 mm/minute) is then performed at 23° C., whereby the Young's modulus can be obtained by a secant equation at a strain of 2.5%.

A method for manufacturing an optical fiber according to the present embodiment includes an applying step of applying the resin composition according to the present embodiment to the outer circumference of a glass fiber including a core and a clad and a curing step of curing the resin composition by radiating an ultraviolet ray after the applying step. The method for manufacturing an optical fiber according to the present embodiment enables an optical fiber having a high biomass degree and excellent low-temperature characteristic to be manufactured using the resin composition according to the present embodiment as a resin composition for primary coating.

### (Optical Fiber Ribbon)

It is possible to produce an optical fiber ribbon using the optical fiber according to the present embodiment. In the optical fiber ribbon, a plurality of the optical fibers are arranged in parallel and coated with a ribbon resin.

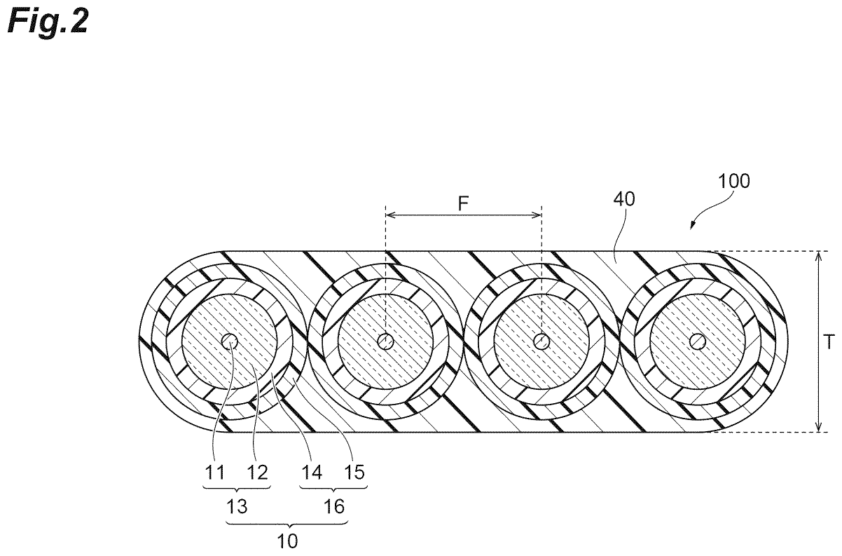

FIG. 2 is a schematic cross-sectional view showing an optical fiber ribbon according to one embodiment. An optical fiber ribbon 100 has a plurality of optical fibers 10 and a connecting resin layer 40 in which the optical fibers 10 are (integrally) coated with a ribbon resin and connected with each other. FIG. 2 shows four optical fibers 10 as an example, but the number of the optical fibers is not particularly limited.

The optical fibers 10 may be integrated with each other in a state of being arranged in parallel to and in contact with each other or may be integrated with each other in a state where a part or all of the optical fibers 10 are arranged in parallel at regular intervals. The center to center distance F of the optical fibers 10 adjacent to each other may be 220 μm or more and 280 μm or less. In a case where the center to center distance is set to 220 μm or more and 280 μm or less, it is easy to place an optical fiber in an existing V groove, and an optical fiber ribbon having excellent collective fusion properties can be obtained. The thickness T of the optical fiber ribbon 100 may be 164 μm or more and 285 μm or less while also depending on the outer diameter of the optical fiber 10.

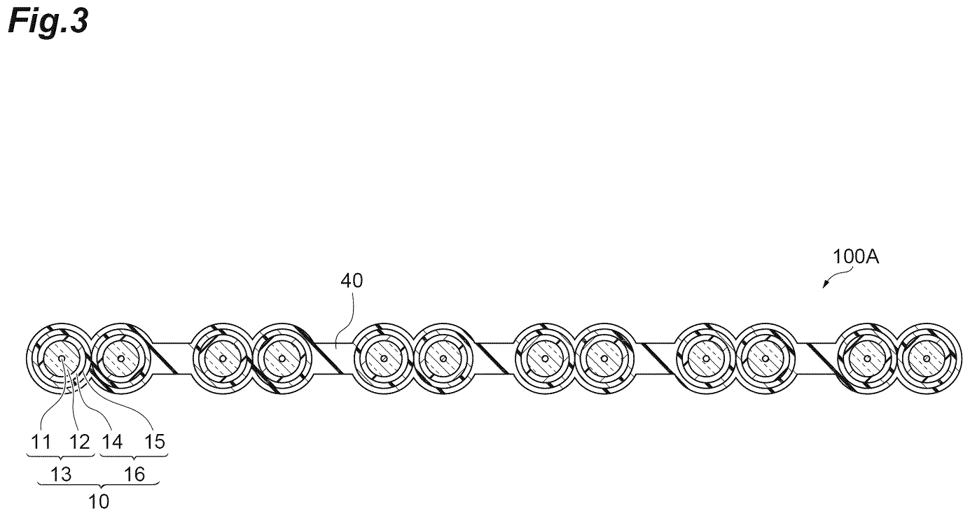

FIG. 3 is a schematic cross-sectional view showing one example of an optical fiber ribbon in which the optical fibers are integrated with each other in a state of being arranged in parallel at a regular interval. In an optical fiber ribbon 100A shown in FIG. 3, two optical fibers 10 are connected with the ribbon resin at a regular interval such that 12 optical fibers are connected. The ribbon resin forms the connecting resin layer 40.

As the ribbon resin, it is possible to use a resin material that is generally known as a ribbon material. From the viewpoint of the damage prevention, easy splitting or the like of the optical fiber 10, the ribbon resin may also contain a thermosetting resin such as a silicone resin, an epoxy resin or a urethane resin or an ultraviolet curable resin such as epoxy acrylate, urethane acrylate or polyester acrylate.

In a case where the optical fibers 10 are arranged in parallel at regular intervals, that is, the optical fibers 10 adjacent to each other are joined to each other through the ribbon resin without being in contact with each other, the thickness of the connected portion at the center between the optical fibers 10 may be 150 μm or more and 220 μm or less. Since the optical fiber ribbon is likely to deform when being stored in a cable, the optical fiber ribbon may have a dent in the connected portion of the optical fibers. The dent may be formed in a triangular shape having a decreasing angle on one side of the connected portion.

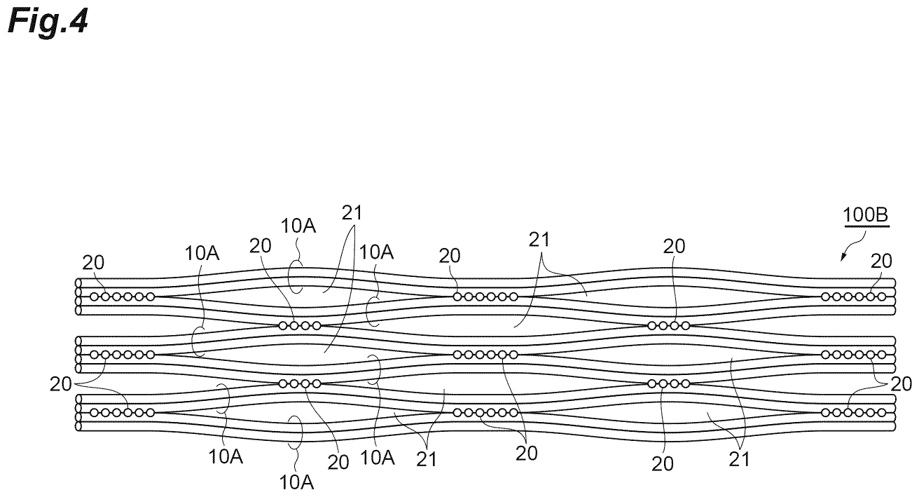

The optical fiber ribbon according to the present embodiment may intermittently have the connected portions and non-connected portions in the longitudinal direction and in the width direction. FIG. 4 is a plan view showing the appearance of an optical fiber ribbon according to one embodiment. An optical fiber ribbon 100B has a plurality of optical fibers, a plurality of connected portions 20 and non-connected portions (split portions) 21. The non-connected portions 21 are intermittently formed in the longitudinal direction of the optical fiber ribbon. The optical fiber ribbon 100B is an intermittently connected optical fiber ribbon in which the connected portions 20 and the non-connected portions 21 are intermittently provided in the longitudinal direction every two optical fibers 10A. The “connected portion” refers to a portion in which the optical fibers adjacent to each other are integrated with each other through the connecting resin layer, and the “non-connected portion” refers to a portion in which the optical fibers adjacent to each other are not integrated with each other through the connecting resin layer and there is a gap between the optical fibers.

In the optical fiber ribbon having the above-described configuration, since the non-connected portions 21 are intermittently provided in the connected portions 20 provided every two cores, the optical fiber ribbon easily deforms. Therefore, the optical fiber ribbon can be easily curled and mounted when being mounted in an optical fiber cable, and it is thus possible to make the optical fiber ribbon suitable for high-density mounting. In addition, since it is possible to easily tear the connected portions 20 from the non-connected portions 21 as starting points, the single-core separation of the optical fibers 10 in the optical fiber ribbon becomes easy.

By using the optical fiber described above, the optical fiber ribbon according to this embodiment has a high biomass degree, is excellent in the low-temperature characteristic, and can be filled in the optical fiber cable with a high density.

### (Optical Fiber Cable)

In an optical fiber cable according to the present embodiment, the above-described optical fiber ribbon is stored in a cable. Examples of the optical fiber cable include slot-type optical fiber cables having a plurality of slots (grooves). In the slots, the optical fiber ribbon can be mounted such that the mounting density in each slot becomes approximately 25% to 65%. The mounting density means the proportion of the cross-sectional area of the optical fiber ribbon that is mounted in the slot in the cross-sectional area of the slot. The optical fiber cable according to the present embodiment may be an aspect in which the plurality of optical fibers are stored in a cable without being coated with the ribbon resin.

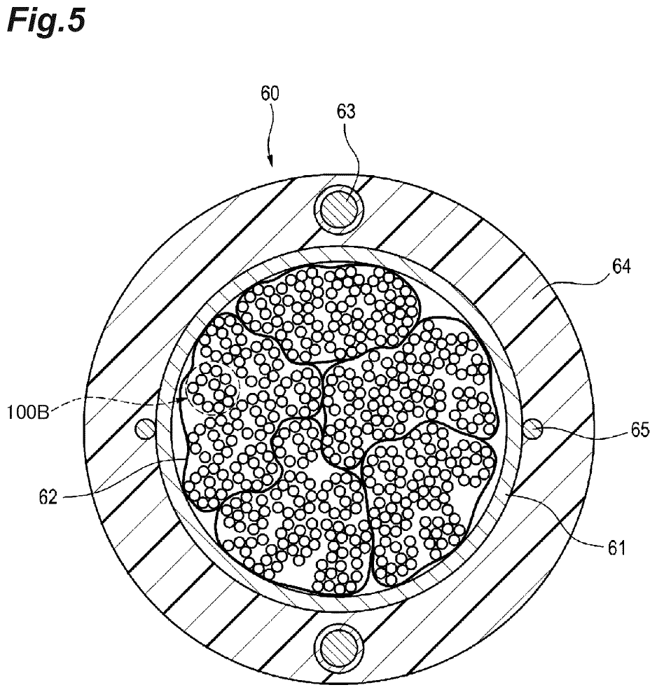

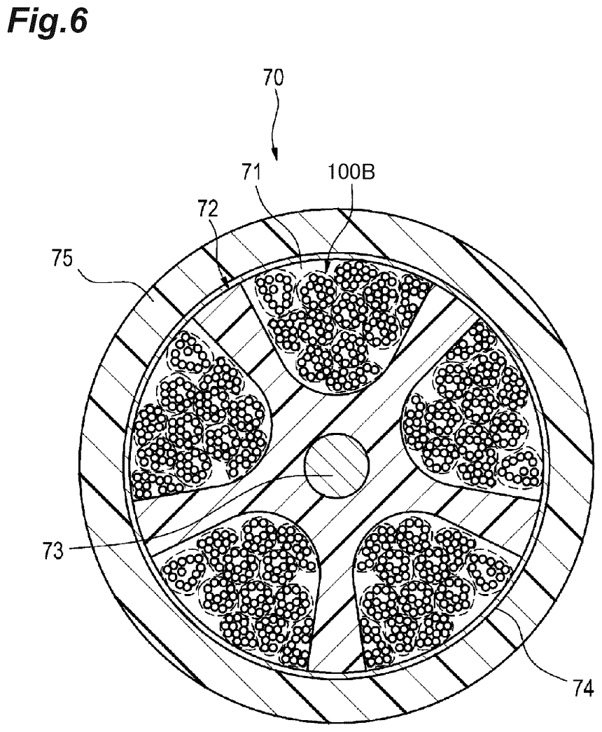

One example of the optical fiber cable according to the present embodiment will be described with reference to FIG. 5 and FIG. 6. In FIG. 5 and FIG. 6, intermittently connected optical fiber ribbons are stored, but a plurality of optical fibers not coated with the ribbon resin may be stored in a bundled state.

FIG. 5 is a schematic cross-sectional view showing a slot-less type optical fiber cable 60 in which the above-described intermittently connected optical fiber ribbons 100B are used. The optical fiber cable 60 has a cylindrical tube 61 and a plurality of the optical fiber ribbons 100B. The plurality of optical fiber ribbons 100B may be bundled together by intervention 62 of an aramid fiber or the like. In addition, the plurality of optical fiber ribbons 100B may each have a different marking. The optical fiber cable 60 has a structure in which the plurality of optical fiber ribbons 100B bundled together is twisted, a resin that is to be the tube 61 is extruded onto the circumference of the optical fiber ribbons and an external coat 64 is formed to cover the circumference together with tension members 63. In a case where a waterproof property is required, a water-absorbing yarn may be inserted into the tube 61. The tube 61 can be formed using, for example, a resin such as polybutylene terephthalate or high-density polyethylene. Tear strings 65 may be provided on the outside of the tube 61.

FIG. 6 is a schematic cross-sectional view of a slot-type optical fiber cable 70 in which the above-described intermittently connected optical fiber ribbons 100B are used. The optical fiber cable 70 has a slot rod 72 having a plurality of slots 71 and a plurality of the optical fiber ribbons 100B. The optical fiber cable 70 has a structure in which the plurality of slots 71 is radially provided in the slot rod 72 having a tension member 73 in the center. The plurality of slots 71 may be provided in the longitudinal direction of the optical fiber cable 70 in a spiral shape or a SZ-twisted shape. In each slot 71, a plurality of the optical fiber ribbons 100B, which are in a dense state from a state where the optical fiber ribbons are arranged in parallel, are stored. Each optical fiber ribbon 100B may be tied with a bundle material for identification. Wrapping tape 74 is wound around the circumference of the slot rod 72, and an external coat 75 is formed on the circumference of the wrapping tape 74.

The optical fiber cable including the optical fiber or optical fiber ribbon according to the present embodiment has a high biomass degree and excellent low-temperature characteristic.

### EXAMPLES

Hereinafter, the results of evaluation tests in which examples and comparative examples according to the present disclosure were used will be shown, and the present disclosure will be described in more detail. The present disclosure is not limited to these examples.

### Synthesis of urethane (meth)acrylate (B)

### (B-1)

Polypropylene glycol having Mn of 3000 (manufactured by Sanyo Chemical Industries, Ltd., product name “SANNIX PP-3000”) and 2,4-tolylene diisocyanate (TDI) were injected into a reaction pot such that the mole ratio (NCO/OH) of NCO to OH reached 1.5. After that, the components were reacted at 60° C. for one hour to prepare an NCO-terminated prepolymer. As a catalyst, 200 ppm of dibutyltin dilaurate was added with respect to the final total preparation amount, and as a polymerization inhibitor, 500 ppm of 2,6-di-tert-butyl-p-cresol (BHT) was added with respect to the final total preparation amount. Next, methanol was added such that the mole ratio (MeOH/NCO) of OH of methanol to NCO of the NCO-terminated prepolymer reached 0.2, HEA was added such that the mole ratio (HEA/NCO) of OH of 2-hydroxyethyl acrylate (HEA) to NCO of the NCO-terminated prepolymer reached 0.85, and the components were reacted at 60° C. for one hour, thereby obtaining a urethane acrylate (B-1). The urethane acrylate (B-1) had Mn of 13100 and Mw of 17700.

### (B-2)

Polyoxypropylene monobutyl ether having Mn of 5000 (manufactured by NOF Corporation, product name “ACROBUTE MB-90”) and TDI were injected into a reaction pot such that the mole ratio (NCO/OH) of NCO to OH reached 2.0. After that, the components were reacted at 60° C. for one hour to prepare an NCO-terminated prepolymer. As a catalyst, 200 ppm of dibutyltin dilaurate was added with respect to the final total preparation amount, and as a polymerization inhibitor, 500 ppm of 2,6-di-tert-butyl-p-cresol (BHT) was added with respect to the final total preparation amount. Next, HEA was added such that the mole ratio OH of HEA to NCO of the NCO-terminated prepolymer reached 1.05, and the components were reacted at 60° C. for one hour, thereby obtaining a urethane acrylate (B-2). The urethane acrylate (B-2) had Mn of 10000 and Mw of 17000.

The Mn's of the polypropylene glycol and the polyoxypropylene monobutyl ether are values obtained from hydroxyl values and a value described in the catalog of each product. The Mn's and Mw's of the urethane acrylates were measured using an ACQUITY APC RI system manufactured by Waters Corporation under conditions of sample concentration: 0.2 mass % THE solution, injection amount: 20 μL, sample temperature: 15° C., mobile phase: THF, XT column for organic solvent: particle diameter of 2.5 μm, pore size of 450 angstroms, column inner diameter 4.6×column length 150 mm+particle diameter of 2.5 μm, pore size of 125 angstroms, column inner diameter 4.6×column length 150 mm+particle diameter of 1.7 μm, pore size of 45 angstroms, column inner diameter 4.6×column length 150 mm, column temperature: 40° C. and flow rate: 0.8 mL/minute.

As a urethane (meth)acrylate (A), the following urethane acrylate (A-1) was prepared.
Urethane acrylate (A-1): SARBIO 7404NS (biomass degree: 54%, Mn: 13000, Mw: 21200, Tg: −67° C., number of functional groups: two) manufactured by Arkema

As monomers derived from a plant component, the following monomers were prepared.
IBXA: Isobornyl acrylate (biomass degree: 66%)
STA: Stearyl acrylate (biomass degree: 78%)
M-910: Glycerin carbonate acrylate (manufactured by Toagosei Co., Ltd., product name “ARONIX M-910”, biomass degree: 53%)
DDA: Decanediol diacrylate (manufactured by Arkema, product name “SARBIO 5201NS”, biomass degree: 50%)

As monomers derived from a petroleum component, the following monomers were prepared.
M164: Nonylphenol polyethylene glycol acrylate (manufactured by Miwon Specialty Chemical Co., Ltd., product name “Miramer M164”)
ACMO: Acryloyl morpholine
NVCL: N-vinylcaprolatam

As a photopolymerization initiator, 2,4,6-trimethylbenzoyldiphenylphosphine oxide (Omnirad TPO) was prepared. 3-Acryloyloxypropyltrimethoxysilane (APTMS) was prepared as a silane coupling agent.

### [Resin Composition for Primary Coating]

Each component was mixed in a blended amount (parts by mass) shown in Table 1 to produce a resin composition for primary coating of each test example. Test Examples 1 to 7 correspond to the examples, and Test Examples 8 and 9 correspond to the comparative examples.

### (Viscosity)

The viscosity at 25° C. of the resin composition was measured using a rheometer (“MCR-102” manufactured by Anton Paar GmbH) with corn-plate CP25-2 under conditions of a shear rate of 10 s⁻¹.

### [Resin Film]

The resin composition was applied onto a polyethylene terephthalate (PET) film using a spin coater and cured with ultraviolet rays using an electrodeless UV lamp system (D valve, manufactured by Heraeus) under conditions of an integrated light quantity of 10 mJ/cm² and an illuminance of 100 mW/cm², thereby forming a 200 μm-thick resin layer on the PET film. The resin layer was peeled off from the PET film, thereby obtaining a resin film 1. A resin film 2 was obtained by the same operation as for the resin film 1 except that the integrated light quantity was changed to 100 mJ/cm².

### (Young's Modulus)

The resin film was punched out into a dumbbell shape of JIS K 7127 Type 5 and pulled under conditions of 23±2° C. and 50±10% RH using a tensile tester under conditions of a tensile rate of 1 mm/minute and a marked line-to-marked line distance of 25 mm, thereby obtaining a stress-strain curve. Stress obtained by a secant equation at a strain of 2.5% was divided by the cross-sectional area of the resin film, thereby obtaining the Young's modulus of the resin film. The Young's modulus Y1 of the resin film 1, the Young's modulus Y2 of the resin film 2 and the ratio (Y1/Y2) of the Young's modulus Y1 of the resin film 1 to the Young's modulus Y2 of the resin film 2 are each shown in Table 1.

### [Resin Composition for Secondary Coating]

Polypropylene glycol having Mn of 600 (manufactured by Sanyo Chemical Industries, Ltd., product name “PP-600”) and TDI were reacted with each other such that NCO/OH reached 2.0, thereby preparing an NCO-terminated prepolymer. 200 ppm of dibutyltin dilaurate with respect to the final total preparation amount was added as a catalyst, and 500 ppm of BHT with respect to the final total preparation amount was added as a polymerization inhibitor. Next, HEA was added such that the mole ratio of OH of HEA to NCO of the NCO-terminated prepolymer reached 1.05, and the components were reacted at 60° C. for one hour, thereby obtaining a urethane acrylate (Z-1). The urethane acrylate (Z-1) had Mn of 3200 and Mw of 3800.

30 Parts by mass of the urethane acrylate (Z-1), 30 parts by mass of tripropylene glycol diacrylate, 40 parts by mass of bisphenol A epoxy di(meth)acrylate (manufactured by Osaka Organic Chemical Industry Ltd., product name “VISCOAT #540”), 1 part by mass of Omnirad TPO and 1 part by mass of 1-hydroxycyclohexyl phenyl ketone (Omnirad 184) were mixed together, thereby obtaining a resin composition for secondary coating.

### [Optical Fiber]

The resin composition for primary coating and the resin composition for secondary coating were each applied to the outer circumferential surface of a glass fiber 13 having a diameter of 125 μm. Next, each resin composition was cured by radiating ultraviolet rays, a coating resin layer 16 including a primary resin layer 14 and a secondary resin layer 15 was formed, and an optical fiber 10 was produced. The thickness of the primary resin layer 14 was set to 35 μm, the thickness of the secondary resin layer 15 was set to 25 μm, and an optical fiber having an outer diameter of 245 μm was obtained. The optical fiber was produced at a manufacturing rate of 3000 m/minute.

### (Low-Temperature Characteristic)

A single-layer of the optical fiber was wound around a glass bobbin with tension of 50 g, the transmission characteristic of signal light having a wavelength of 1550 nm were measured under a temperature condition of each of 23° C. and −40° C., and the transmission loss was obtained. A transmission loss difference that was obtained by subtracting the transmission loss at 23° C. from the transmission loss at −40° C. of 0.01 dB/km or less was evaluated as “A”, and a transmission loss difference of more than 0.01 dB/km was evaluated as “B.”

TABLE 1

| | Biomass | Test Examples | | | | | | | | |
|---|---|---|---|---|---|---|---|---|---|---|
| | degree (%) | 1 | 2 | 3 | 4 | 5 | 6 | 7 | 8 | 9 |
| A-1 | 54 | 45 | 45 | 45 | 25 | 30 | 25 | 25 | — | — |
| B-1 | 0 | — | — | — | — | — | — | — | 75 | 75 |
| B-2 | 0 | — | — | — | 50 | 45 | 50 | 50 | — | — |
| IBXA | 66 | — | — | — | — | — | 11 | — | — | 18 |
| STA | 78 | — | — | 12 | — | — | — | 11 | — | — |
| M-910 | 53 | — | 3 | — | — | — | — | — | — | — |
| DDA | 50 | — | — | — | 2 | 2 | 2 | 2 | — | — |
| M164 | 0 | 36 | 33 | 24 | 11 | 11 | — | — | 18 | — |
| ACMO | 0 | 5 | 5 | 5 | 2 | 2 | 2 | 2 | — | — |
| NVCL | 0 | 12 | 12 | 12 | 8 | 8 | 8 | 8 | 5 | 5 |
| TPO | 0 | 1 | 1 | 1 | 1 | 1 | 1 | 1 | 1 | 1 |
| APTMS | 0 | 1 | 1 | 1 | 1 | 1 | 1 | 1 | 1 | 1 |

| | | | | | | | | | |
|---|---|---|---|---|---|---|---|---|---|
| Biomass degree (%) | 24 | 26 | 34 | 15 | 17 | 22 | 23 | 0 | 12 |
| Viscosity (Pa · s) | 9.6 | 9.6 | 7.9 | 5.0 | 5.0 | 3.5 | 3.5 | 7.9 | 5.5 |
| Young's modulus Y1 (MPa) | 0.75 | 0.92 | 0.64 | 0.65 | 0.85 | 0.53 | 0.49 | 0.69 | 0.52 |
| Young's modulus Y2 (MPa) | 1.75 | 1.94 | 1.53 | 0.99 | 1.22 | 1.11 | 0.83 | 1.01 | 1.37 |
| Young's modulus ratio (Y1/Y2) | 0.43 | 0.47 | 0.42 | 0.66 | 0.70 | 0.48 | 0.59 | 0.68 | 0.38 |
| Low-temperature characteristic | A | A | A | A | A | A | A | A | B |

### REFERENCE SIGNS LIST

10, 10A . . . optical fiber
11 . . . core
12 . . . clad
13 . . . glass fiber
14 . . . primary resin layer
15 . . . secondary resin layer
16 . . . coating resin layer
20 . . . connected portion
21 . . . non-connected portion
40 . . . connecting resin layer
60, 70 . . . optical fiber cable
61 . . . cylindrical tube
62 . . . intervention
63, 73 . . . tension member
64, 75 . . . external coat
65 . . . tear string
71 . . . slot
72 . . . slot rod
74 . . . wrapping tape
100, 100A, 100B . . . optical fiber ribbon
D1 . . . diameter of core 11
D2 . . . outer diameter of glass fiber 13
F . . . center to center distance
T . . . thickness

What is claimed is:

1. A resin composition for primary coating of an optical fiber, comprising:
a photopolymerizable compound containing a urethane (meth)acrylate derived from a plant component;
a photopolymerization initiator; and
a silane coupling agent.

2. The resin composition according to claim 1,
wherein the urethane (meth)acrylate has a biomass degree of 20% or more and 70% or less.

3. The resin composition according to claim 1,
wherein the urethane (meth)acrylate has a weight-average molecular weight of 5000 or more and 35000 or less.

4. The resin composition according to claim 1,
wherein a content of the urethane (meth)acrylate is 10 parts by mass or more and 80 parts by mass or less based on 100 parts by mass of a total amount of the resin composition.

5. The resin composition according to claim 1,
wherein the photopolymerizable compound further contains a monomer derived from a plant component.

6. The resin composition according to claim 1,
wherein the photopolymerizable compound further contains a N-vinyl compound, and a content of the N-vinyl compound is 1 part by mass or more and 15 parts by mass or less based on 100 parts by mass of a total amount of the resin composition.

7. The resin composition according to claim 1,
wherein a biomass degree of the resin composition is 10% or more and 50% or less.

8. An optical fiber comprising:
a glass fiber including a core and a clad;
a primary resin layer being in contact with the glass fiber and coating the glass fiber; and
a secondary resin layer coating the primary resin layer,
wherein the primary resin layer contains a cured product of the resin composition according to claim 1.

9. A method for manufacturing an optical fiber, comprising:
an applying step of applying the resin composition according to claim 1 to an outer circumference of a glass fiber including a core and a clad; and
a curing step of curing the resin composition by radiating an ultraviolet ray after the applying step.

10. An optical fiber ribbon,
wherein a plurality of the optical fibers according to claim 8 are arranged in parallel and coated with a ribbon resin.

11. An optical fiber cable,
wherein the optical fiber ribbon according to claim 10 is stored in a cable.

12. An optical fiber cable,
wherein a plurality of the optical fibers according to claim 8 are stored in a cable.
